(19) United States
(12) Patent Application Publication
(10) Pub. No.: US 2009/0108020 A1
(43) Pub. Date: Apr. 30, 2009

(54) Disc-discharging Apparatus

(76) Inventor: Shu-Yuan Lee, Panchiao City (TW)

Correspondence Address: Dr. BANGER SHIA, 102 Lindencrest Ct., Sugar Land, TX, 77479-5201, US

(21) Appl. No.: 12/349,367

(22) Filed: Jan. 6, 2009

Related U.S. Application Data
(63) Continuation-in-part of application No. 11/305,319, filed on Dec. 19, 2005.

(51) Int. Cl. B65G 59/00

(52) U.S. Cl. 221/270

(57) ABSTRACT

A disc-discharging apparatus comprises a supporting base, an annular pusher, a drive element and a disc storage base. The annular pusher can be moved to push one end of the disc to fall into a recess of the supporting base, and meanwhile the other end of the disc is limited by a limit groove. At this moment, the disc is in an inclined state and stuck in the space of the limit groove. After the annular pusher returns to its original position, the end of the disc, which is limited by the limit groove, will be pushed by annular pusher to fall into the recess of the supporting base, finally finishing a discharging operation.

This application is a continuation of part of U.S. patent application Ser. No. 11/305,319, which claims the benefit of the earlier filing date of Dec. 19, 2005. Claims 1-4 of this application corresponds to the previous claims 1-4 of the U.S. patent application Ser. No. 11/305,319, claim 5 of this application is new, claims 6-9 of this application correspond to the previous claims 6-9 of the U.S. patent application Ser. No. 11/305,319, and claim 10 of this application is new.

### BACKGROUND OF THE INVENTION

1. Field of the Invention

The present invention relates to a disc-discharging apparatus, and more particularly to a disc-discharging apparatus, which can discharge stacked discs one by one precisely.

2. Description of the Prior Art

Optical disc has found a wide application, for example, video/audio disc and data disc, and it also can be used as a memory medium for storage of company or personal data.

The existing disc-discharging method generally involves a mechanical arm mainly consisted of a connecting rod assembly, a suction disc and other component, wherein the suction disc is employed to hold the optical disc, and then the mechanical arm is used to transport it to a predetermined position. However, this conventional disc-discharging method still has the following disadvantages that need to be improved:

First, since the connecting structure between the connecting rod assembly and the suction disc is complicated, and it also requires many control circuits, therefore, the resultant cost is relatively high.

Second, the conventional discharging procedure is complicated and includes many steps, such sucking, transporting, and releasing, therefore, the conventional discharging method is time consuming and has a long working travel, imperceptibly increasing the production cost.

Third, the conventional disc-discharging apparatus is complicated and expensive, therefore, it is usually used in factory and is unsuitable for commercial and personal use.

Usually, a company or an individual will use optical discs as a medium for preservation of data, and most of the discs are stored in a disc container. The user has to open the container, taking out the disc, and then close the container again, so it is really inconvenient.

The present invention has arisen to mitigate and/or obviate the afore-described disadvantages.

### SUMMARY OF THE INVENTION

The primary objective of the present invention is to provide a disc-discharging apparatus which is simplified in structure and can discharge the discs one by one precisely.

The secondary objective of the present invention is to provide a low cost disc-discharging apparatus.

Another objective of the present invention is to provide a disc-discharging apparatus to discharge the discs more quickly.

Yet, another objective of the present invention is to provide an easily operated disc-discharging apparatus.

In order to achieve the above objectives, a disc-discharging apparatus in accordance with the present invention comprises:

A supporting base includes a through recess and a sliding groove formed between a peripheral edge of the recess and the supporting base, the peripheral edge of the recess includes a first loading portion and a second loading portion that are oppositely arranged.

An annular pusher includes a first and second push portions that are oppositely arranged, the annular pusher is slidably assembled to the sliding groove of the supporting base, and the first and second push portions are located in a superposition or staggered manner with respect to the first and second loading portions.

A drive element is employed to control the annular pusher 30 to move in the sliding groove of the supporting base.

A disc storage base is defined with a disc holding hole in alignment with the recess of the supporting base, the disc storage base is disposed on the supporting base and covers the pusher, the first loading portion and the second loading portion of the supporting base are exposed in the disc-holding hole, the disc-holding hole includes a first concave in a surface thereof, the first concave and a groove bottom surface of the sliding groove of the supporting base define a limit groove for passage of the second push portion of the annular pusher, a longitudinal height of the limit groove is greater than a thickness of a single disc and smaller than a thickness of two stacked discs.

### BRIEF DESCRIPTION OF THE DRAWINGS

FIG. 1 is a perspective exploded view of a disc-discharging apparatus in accordance with the present invention;

FIG. 2 is a perspective assembly view of the disc-discharging apparatus in accordance with the present invention;

FIG. 3 is a top view of the disc-discharging apparatus in accordance with the present invention, illustrating how the annular pusher is assembled to the supporting base;

FIG. 4 is a cross-sectional view of the disc-discharging apparatus in accordance with the present invention;

FIG. 5 is a first top view of the discharging state of the present invention, illustrating how the disc is located with respect to the first loading portion of the supporting base and the second push portion of the annular pusher;

FIG. 6 is a first cross-sectional view of the discharging state of the present invention, illustrating how the disc is located with respect to the first loading portion of the supporting base and the second push portion of the annular pusher;

FIG. 7 is a second top view of the discharging state of the present invention, illustrating how the disc is located with respect to the first loading portion and the second loading portion of the supporting base;

FIG. 8 is a second cross-sectional view of the discharging state of the present invention, illustrating how the disc is located with respect to the first loading portion and the second loading portion of the supporting base;

FIG. 9 is a third top view of the discharging state of the present invention, illustrating how the disc is limited by the limit groove;

FIG. 10 is a third cross-sectional view of the discharging state of the present invention, illustrating how the disc is limited by the limit groove;

FIG. 11 is a fourth cross-sectional view of the discharging state of the present invention, illustrating the state of the disc after being pushed to fall off; and

FIG. 12 is an exploded view of a disc-discharging apparatus in accordance with another embodiment, illustrating that the second push portion of the annular pusher is adhered with an anti-scratch film.

### DETAILED DESCRIPTION OF THE PREFERRED EMBODIMENTS

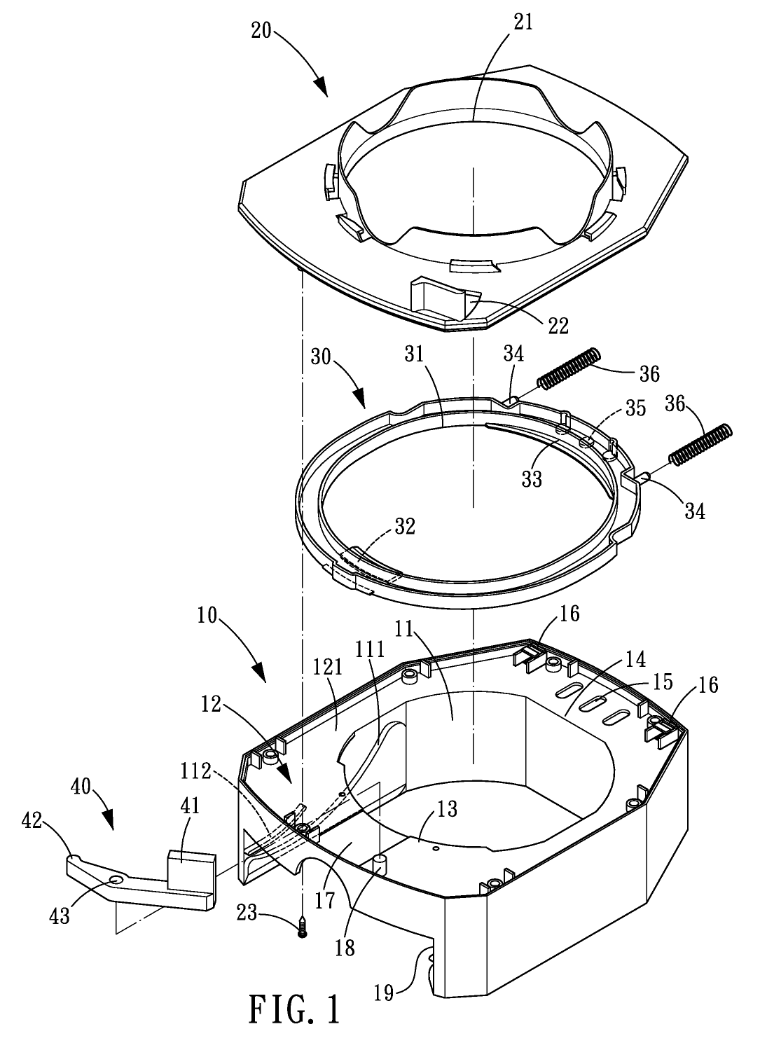

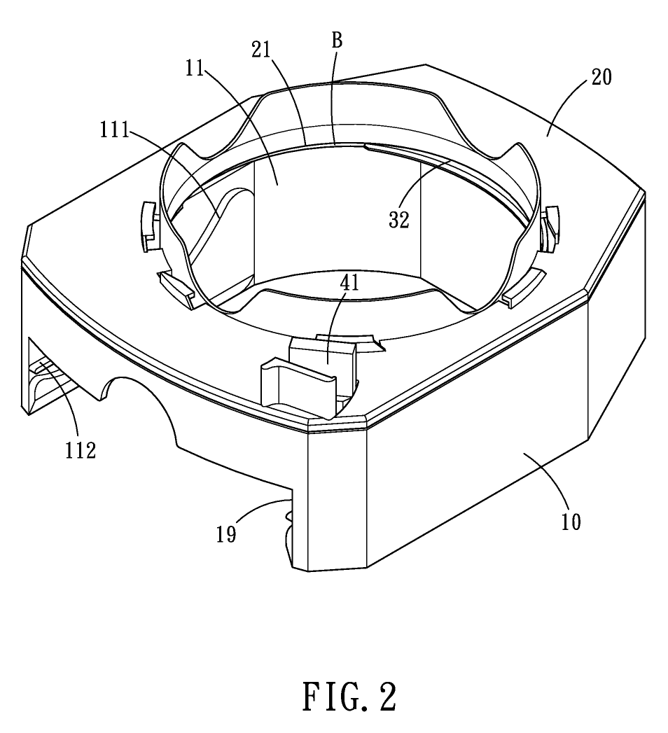

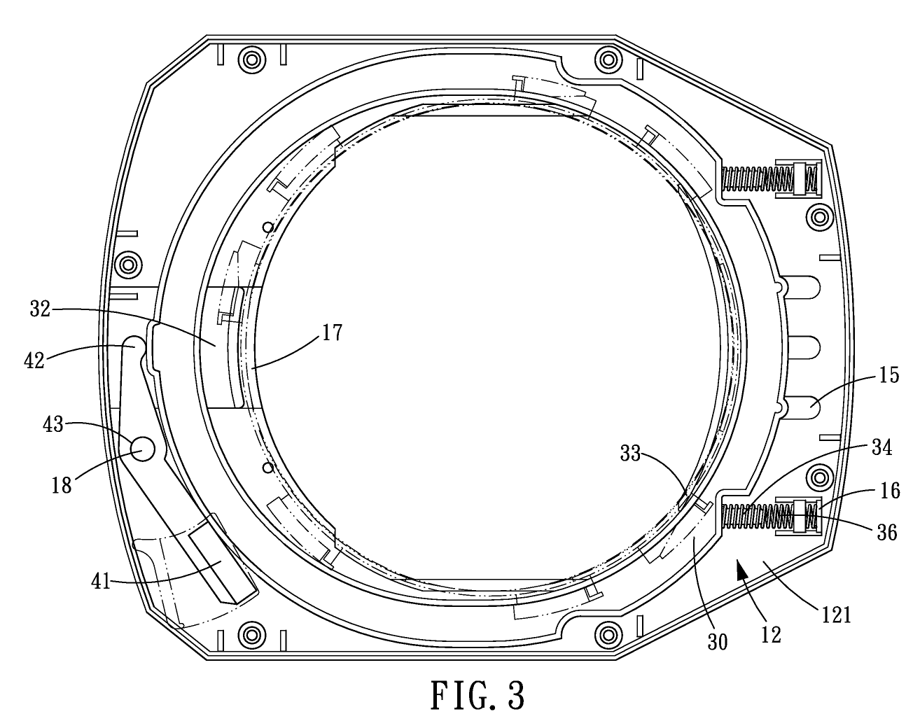

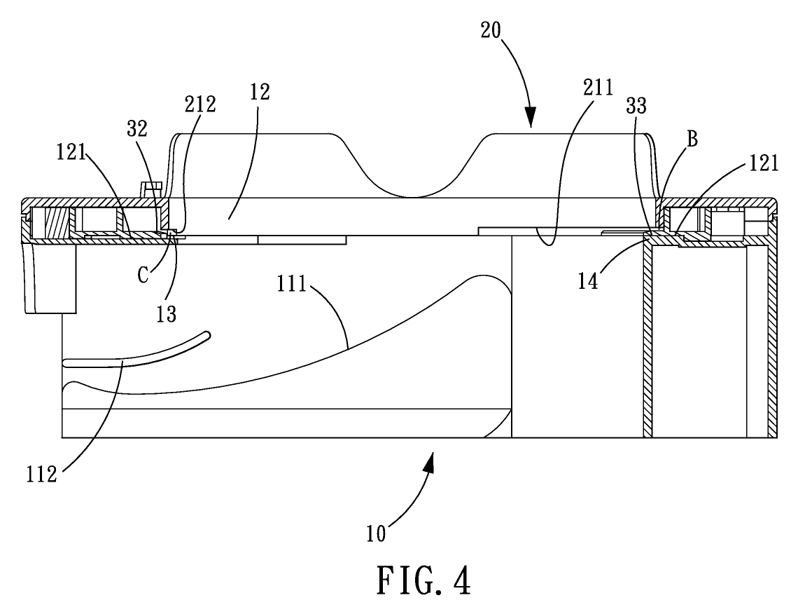

Referring to FIGS. 1-4, a disc-discharging apparatus in accordance with the present invention comprises a supporting base 10, a disc storage base 20, an annular pusher 30 and a drive element 40 employed to drive the annular pusher 30 to slide.

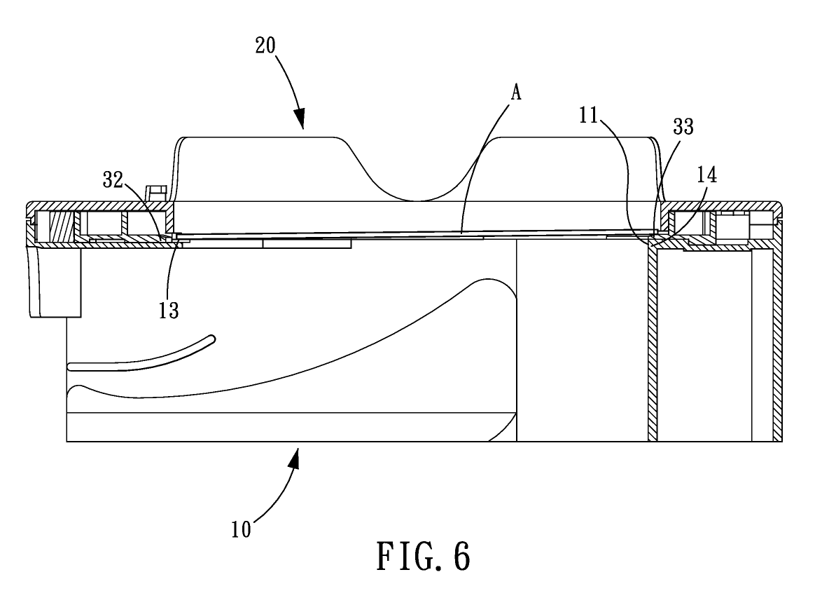

The supporting base 10 includes a through recess 11 and a sliding groove 12 defined between a peripheral edge of the recess 11 and the supporting base 10. The peripheral edge of the recess 11 includes a first loading portion 13 and a second loading portion 14 that are oppositely arranged, and a minimal distance between the first loading portion 13 and the second loading portion 14 is smaller than a diameter of the disc A (as shown in FIG. 6). Further, a groove bottom surface 121 of the sliding groove 12 of the supporting base 10 is provided with three guiding grooves 15, two stopping portions 16, a notch 17 and a protrusion 18. The two stopping portions 16 are located adjacent to the second loading portion 14, the respective guiding grooves 15 are located between the two stopping portions 16, the notch 17 is formed in the upper end surface of the first loading portion 13, and the protrusion 18 is located adjacent to the notch 17. The supporting base 10 is defined with a discharging exit 19 in the sliding direction of the annular pusher 30, and the bottom of the recess 11 of the supporting base 10 is provided with a slant discharging surface 111 inclining from the recess 11 toward the discharging exit 19, and the supporting base 10 is further provided with two discharging guide elements 112 corresponding to the recess 11. The two discharging guide elements 112 are disposed at two opposite sides of the supporting base 10 and incline from the recess 11 toward the discharging exit 19.

The disc storage base 20 can be assembled to a disc container (not shown). The disc storage base 20 is defined with a disc holding hole 21 in alignment with the recess 11 of the supporting base 10, and a through hole 22 adjacent to the disc-holding hole 21. The disc storage base 20 is assembled on the supporting base 10 by screws. The first loading portion 13 and the second loading portion 14 of the supporting base 10 are exposed in the disc-holding hole 21. In addition, the disc-holding hole 21 includes a first concave 211 and a second concave 212 in a surface thereof. The first concave 211 and the groove bottom surface 121 of the sliding groove 12 of the supporting base 10 define a limit groove B. The longitudinal height of the limit groove B is greater than a thickness of a single disc A and smaller than a thickness of two stacked discs A. The second concave 212 and the notch 17 of the supporting base 10 define a sliding space C.

The pusher 30 is a frame structure formed with a through hole 31 and includes a first push portion 32 and a second push portion 33 that are oppositely arranged. The first and second push portions 32, 33 both extend from the inner surface toward the center of the through hole 31, and the distance between the first and second push portions 32, 33 is right large enough for passage of the disc A. The annular pusher 30 is provided with two fixing portions 34 at its periphery, and the two fixing portions 34 are formed in the sliding direction of the annular pusher 30. In addition, the annular pusher 30 includes three guiding portions 35 on its bottom surface, and the respective guiding portions 35 are located between the two fixing portions 34. The annular pusher 30 is assembled between the supporting base 10 and the disc storage base 20 in such a manner that the pusher 30 is slidably assembled in the sliding groove 12 of the supporting base 10. The three guiding portions 35 are inserted into the three guiding grooves 15, respectively to guide the sliding direction of the annular pusher 30. The first push portion 32 can slide in the notch 17 of the supporting base 10 and pass through the sliding space C, and the second push portion 33 can pass through the limit space B, so that the first and second push portions 32, 33 can be located in a superposition or a staggered manner with respect to the first and second loading portions 13, 14. In addition, the two fixing portions 34 each are installed with a spring 34 in such a manner that one end of the spring 34 is fixed on the fixing portions 34, and the other end of the spring 34 abuts against the stopping portion 16 of the supporting base 10.

The drive element 40 includes a control portion 41, a drive portion 42 and a pivot hole 43 between the control portion 41 and the drive portion 42. The drive element 40 is engaged on the protrusion 18 through the pivot hole 43 so as to be pivoted to the sliding groove 12 of the support base 10. The drive portion 42 is employed to contact the annular pusher 30 to drive the annular pusher 30 to move in the sliding groove 12 of the supporting base 10, and the control portion 41 penetrates the through hole 22 of the disc storage base 20 to extend out of the disc storage base 20 so as to be operated by the user.

According to the abovementioned disc-discharging apparatus, when the disc abut between first loading portion and the second loading portion and is located at an entry of the limit groove and located on the moving path of the annular pusher, since the longitudinal height of the limit groove is designed to be bigger than the thickness of a single disc and smaller than a thickness of two stacked discs, the annular pusher can be ensured to push only one disc, thus achieving the objective of precisely discharging a single disc.

In addition, according to the abovementioned disc-discharging apparatus, the annular pusher, the first loading portion, the second loading portion and the drive element are arranged to make the optical discs be discharged according to operation, thus simplifying the disc-discharging apparatus.

Furthermore, according to the abovementioned disc-discharging apparatus, the annular pusher, the first loading portion, the second loading portion and the drive element are arranged to both reduce the disc discharging time and reduce the production cost.

Finally, according to the abovementioned disc-discharging apparatus, the pusher, the annular pusher, the first loading portion, the second loading portion and the drive element are arranged to make the disc-discharging apparatus suitable for commercial and personal use due to the advantages of simplified structure, easy to operate and lower cost.

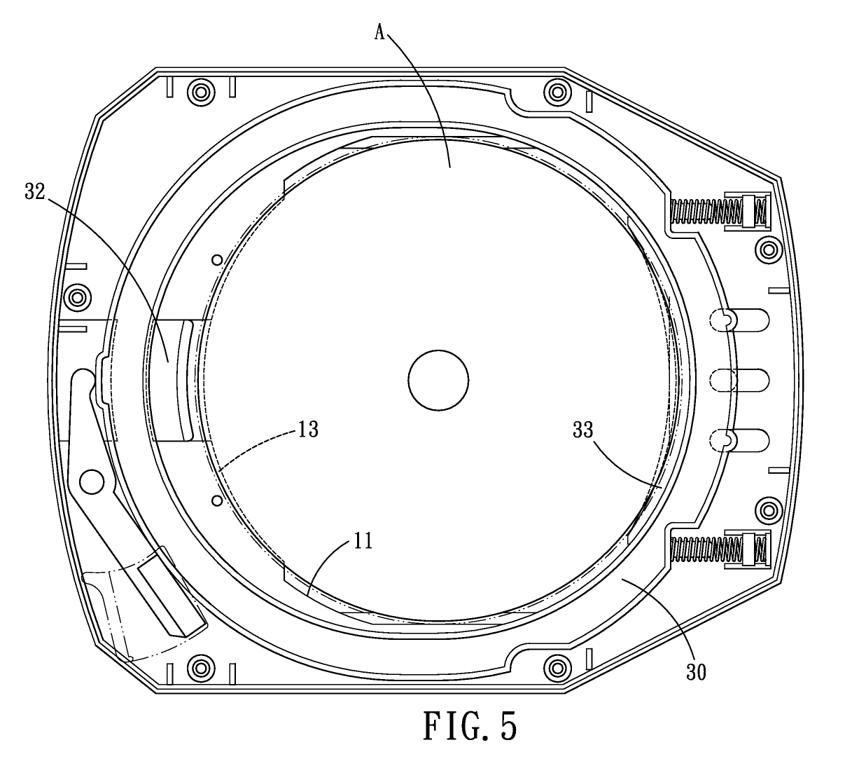

For a better understanding of the present invention, its operation, reference should be made further to FIGS. 5-11.

FIGS. 5-6 illustrate the state of preparing to discharge a disc.

If the disc-discharging apparatus is not operated, the first push portion 32 of the annular pusher 30 is retracted into the recess 11 of the supporting base 10 and is staggered with the first loading portion 132 of the supporting base 10, the second push portion 33 of the annular pusher 30 is exposed in the recess 11 of the supporting base 10 and superposed on the second loading portion 14, so that when the disc A is stored in the disc-holding space of the disc storage base 20, the disc A will abut against the first loading portion 13 of the supporting base 10 and the second push portion 33 of the annular pusher 30 without falling off.

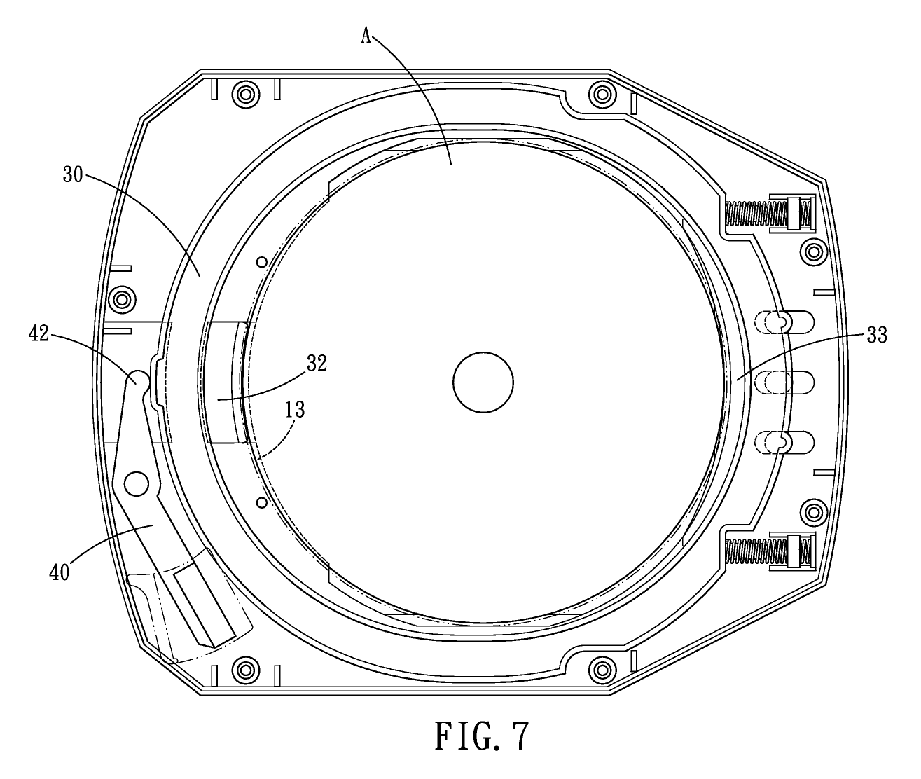

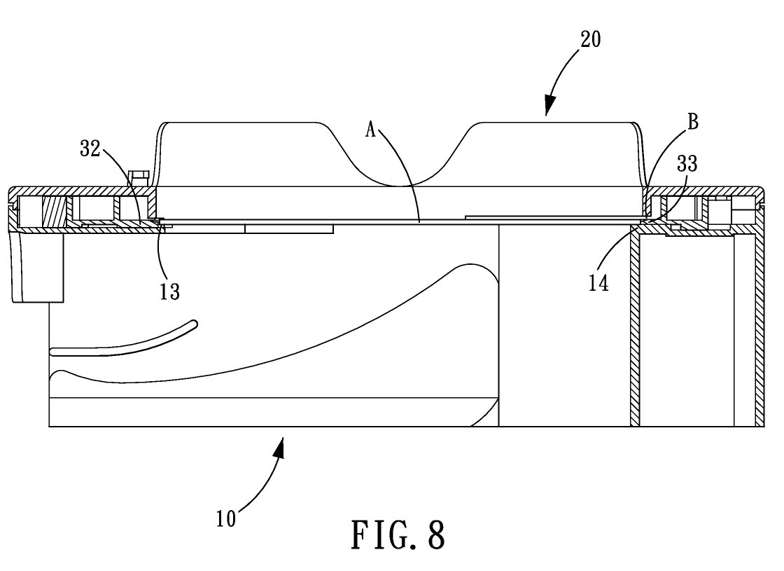

FIGS. 7-8 illustrate a first state of starting to discharge the disc.

At this moment, the drive element 40 is pushed to make the drive portion 42 push against the annular pusher 30, the second push portion 33 retracts in the limit groove B defined by the disc storage base 20 and the supporting base 10 until the second push portion 20 is staggered with the second loading portion 14, the disc A abuts between the first loading portion 13 and the second loading portion 14 for making the disc A completely locate on the moving path of annular pusher 30 besides locating at an entry of the limit groove B.

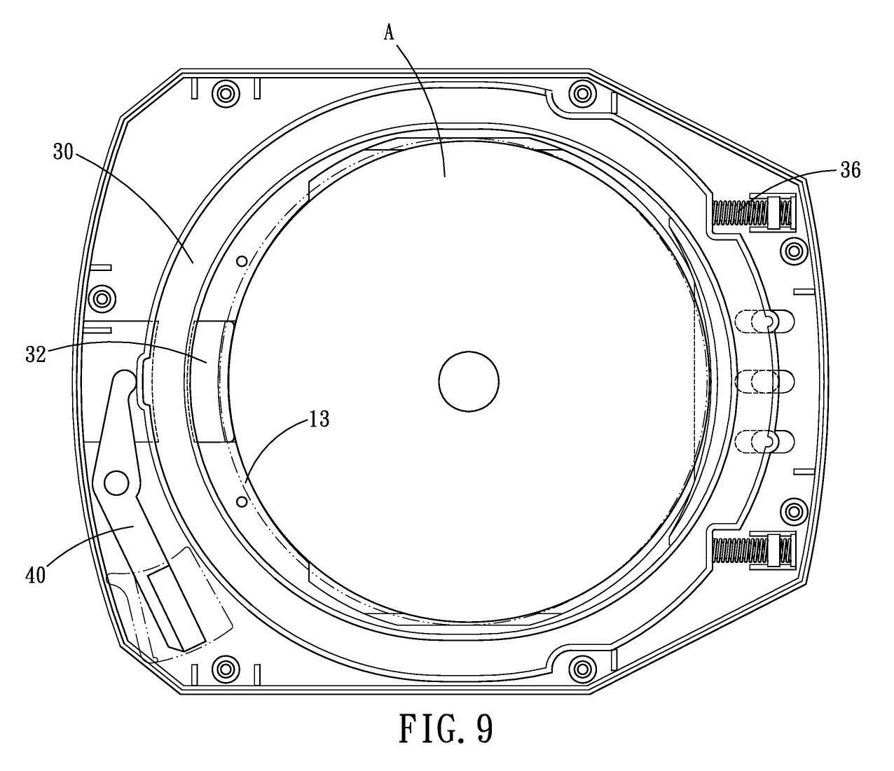

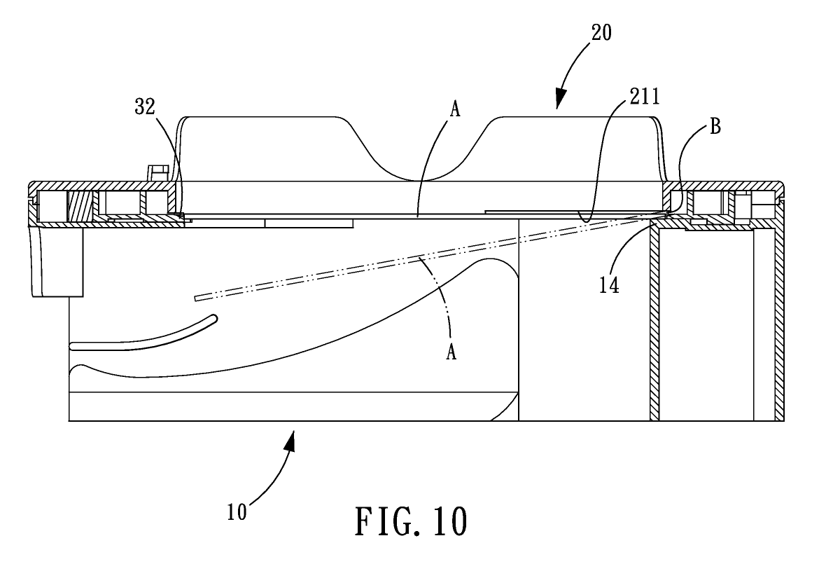

FIGS. 9-10 illustrate a second state of starting discharging the disc.

After that, the drive element 40 will be pushed continuously to make the first push portion 32 of the annular pusher 30 push the disc A to move toward the limit groove B, at this moment, one part of the periphery of the disc A is located in the limit groove B, and the other part of the periphery of the disc A doesn't abut against the first loading portion 13 any longer, meanwhile the disc A will fall off under the action of gravity, since the part of the periphery of the disc A is located in the limit groove B, the disc A will be limited by the limit groove B to incline downwards, namely the disc A is clamped between the first concave 211 of the disc storage groove 20 and the second loading portion 14 of the supporting base 10. In addition, the springs 36 opposite the annular pusher 20 will be compressed while the annular pusher 20 slide.

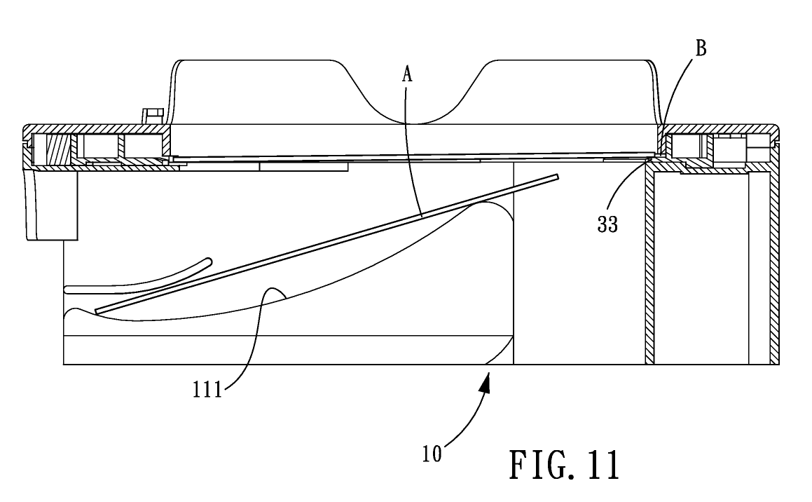

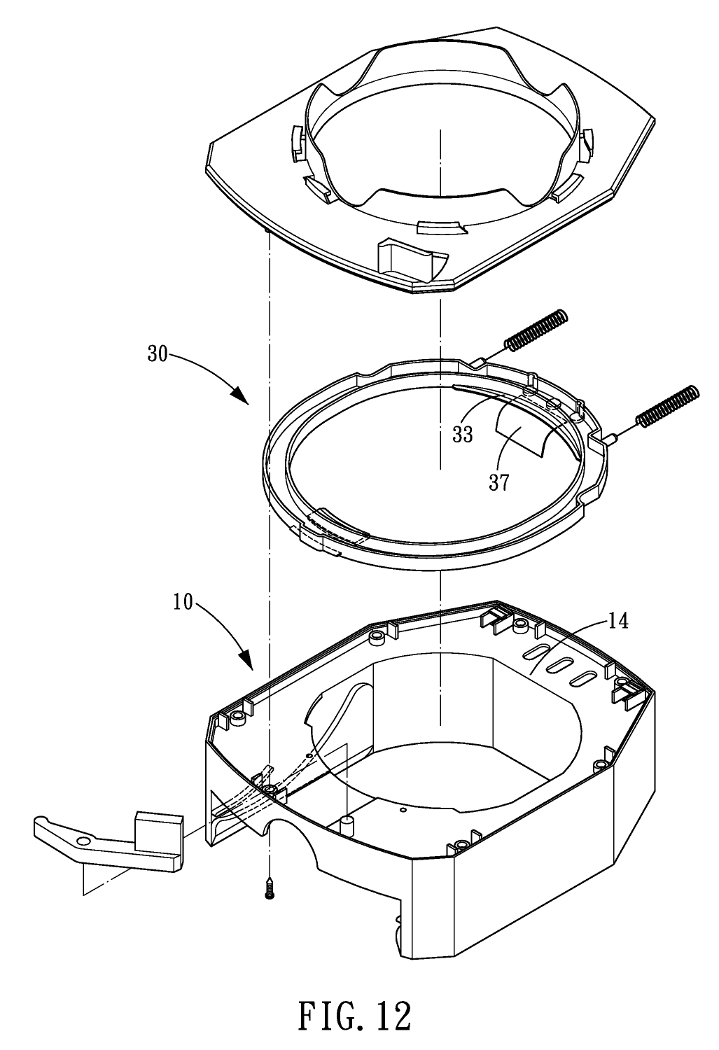

FIGS. 11-12 illustrate a state of finishing discharging the disc.

Ultimately referring to FIGS. 9 and 11, after the drive element 40 is released, the springs 36 will restore to their original state to push the annular pusher 30 to return to its original position, while the annular pusher 30 is returning to its original position, the second push portion 33 will push the disc A clamped by the limit groove B to completely release the disc A from the limit groove B, at this moment, the disc A will completely fall into the supporting base 10. Since the slant discharging surface 111 is designed to incline downward and outward, the disc A will be discharged successfully.

Hence, controlling the annular pusher to perform one circulating operation can discharge one disc, and after discharging one disc, the annular pusher will be ready to discharge the next disc.

Referring to FIG. 12, the second push portion 33 of the annular pusher 30 is adhered with an anti-scratch film 37, and the anti-scratch film 37 can also be covered on the second loading portion 14 of the supporting base 10 to prevent the second loading portion 14 from scratching the data storage surface of the disc.

While we have shown and described various embodiments in accordance with the present invention, it should be clear to those skilled in the art that further embodiments may be made without departing from the scope of the present invention.

What is claimed is:

1. A disc-discharging apparatus comprising:
a supporting base including a through recess and a sliding groove formed between a peripheral edge of the recess and the supporting base, the peripheral edge of the recess including a first loading portion and a second loading portion that are oppositely arranged;
an annular pusher including a first and second push portions that are oppositely arranged, the annular pusher being slidably assembled to the sliding groove of the supporting base, and the first and second push portions being located in a superposition or staggered manner with respect to the first and second loading portions;
a drive element being employed to control the annular pusher 30 to move in the sliding groove of the supporting base; and
a disc storage base being defined with a disc holding hole in alignment with the recess of the supporting base, the disc storage base being disposed on the supporting base and covering the pusher, the first loading portion and the second loading portion of the supporting base being exposed in the disc-holding hole, the disc-holding hole including a first concave in a surface thereof, the first concave and a groove bottom surface of the sliding groove of the supporting base defining a limit groove for passage of the second push portion of the annular pusher, a longitudinal height of the limit groove being greater than a thickness of a single disc and smaller than a thickness of two stacked discs.

2. The disc-discharging apparatus as claimed in claim 1, wherein the groove bottom surface of the sliding groove of the supporting base is provided with at least one guiding groove, the annular pusher includes at least one guiding portion to be slidably disposed in the guiding groove of the supporting base.

3. The disc-discharging apparatus as claimed in claim 1, wherein the first and second push portions of the annular pusher both extend from an inner surface toward a center of the annular pusher.

4. The disc-discharging apparatus as claimed in claim 1, wherein the groove bottom surface of the sliding groove of the supporting base includes two stopping portions, the annular pusher is provided with two fixing portions along a sliding direction thereof, the two fixing portions each are installed with a spring in such a manner that one end of the spring is fixed on the fixing portion, and the other end of the spring abuts against the stopping portion of the supporting base.

5. The disc-discharging apparatus as claimed in claim 1, wherein the groove bottom surface of the sliding groove of the supporting base includes a protrusion, the drive element includes a control portion, a drive portion and a pivot hole between the control portion and the drive portion, the drive element is pivotally engaged on the protrusion of the supporting base through the pivot hole.

6. The disc-discharging apparatus as claimed in claim 1, wherein the siding groove of the supporting base is defined with a notch for slidably receiving the first push portion of the annular pusher.

7. The disc-discharging apparatus as claimed in claim 1, wherein the supporting base is provided with a discharging exit in the sliding direction of the annular pusher.

8. The disc-discharging apparatus as claimed in claim 7, wherein a bottom of the recess of the supporting base is provided with a slant discharging surface inclining from the recess toward the discharging exit.

9. The disc-discharging apparatus as claimed in claim 8, wherein the supporting base is further provided with two discharging guide elements corresponding to the recess, the two discharging guide elements are disposed at two opposite sides of the supporting base and both incline from the recess toward the discharging exit.

10. The disc-discharging apparatus as claimed in claim 1, wherein the second push portion of the annular pusher is adhered with an anti-scratch film, and the anti-scratch film is able to cover the second loading portion of the supporting base.
